(19) United States
(12) Patent Application Publication
(10) Pub. No.: US 2019/0019392 A1
(43) Pub. Date: Jan. 17, 2019

(54) Device saving children in hot cars

(71) Applicant: Guixian Lu, Holly, MI (US)

(72) Inventor: Guixian Lu, Holly, MI (US)

(21) Appl. No.: 15/651,061

(22) Filed: Jul. 17, 2017

(51) Int. Cl. G08B 21/02; G08B 21/22; G08B 21/24

(52) U.S. Cl. CPC G08B 21/02; B60Q 5/005; G08B 21/24; G08B 21/22

(57) ABSTRACT

When motion inside a car is detected by two kinds of motion sensor and temperature inside the car is higher than predetermined value, a device will turn on horns and lights of the car. The device also opens the window to let hot air rise out of the car.

### BACK GROUND

718 children die in hot cars since 1998 in USA. When parents forget to take their children out of the car, causing problem. That will happen again and again.

The present invention will save children when children are in hot cars. The present invention is reliable, low cost, easy to install, and convenient to use.

### BRIEF DESCRIPTION OF THE DRAWING

FIG. 1 A Ultrasonic Motion Sensor, an Infrared Motion Sensor2, and a Thermometer3 send signals to AND Gate4. The output of the AND Gate 4 is sent to the Alarm Generator5 which sends out control signal through Switch7 to turn on Horns8, Lights9, and to open Windows10 of the car. Door Opened6 is a signal source of the car. If one of the doors is opened, Door Opened6 will send a signal to close Switch7.

### DETAIL DESCRIPTION

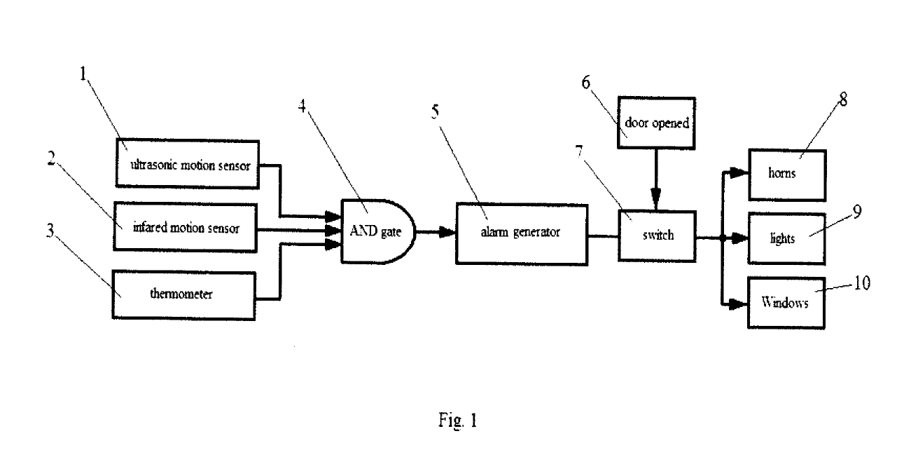

FIG. 1 shows an embodiment. Ultrasonic Motion Sensor1, Infrared Motion Sensor2, and Thermometer3 are installed under the ceiling of a car. Ultrasonic Motion Sensor1 and Infrared Motion Sensor2 detect motion in the car. If something in the car moves, for instance, a baby moves a hand or a foot when he or she doesn't feel comfortable, both motion sensors will give signals indicating the presence of some body in the car. Ultrasonic Motion Sensor1 may give false signal if sound comes from outside of the car with a frequency in the sensitive range of the ultrasonic sensor, for instance an airplane gets close. Infrared Motion Sensor2 may give false signal if infrared from outside of the car changes, for instance, sun shining is changed rapidly by cloud. However the chance that both motion sensors simultaneously give false signals is little. The Thermometer3 sends signal when temperature is higher than a predetermined value. Three signals together mean some body is in the hot car or in danger. Help is needed now. After receives three signals, AND Gate4 sends a signal to activate the Alarm Generator5. Alarm Generator5 sends out control signal through Switch7. The control signal is sent to Windows10 to open windows of the car. Hot air inside the car rises and gets out of windows because hot air is lighter then cooler air. Cooler air get into the car from outside to take over the space. Very soon the temperature of air in the car becomes lower. The control signal also goes to Horns6 and Lights7 and turns on horns and lights of the car to attract attention of people around. People will come and save children in the car. This will increase security of children in hot cars and keep thieve stay away from the car.

If no body is in the hot car and the driver opens car door, the motion sensors detect motion of the door. Those three signal will still let AND Gate4 activate Alarm Generator5. Door Opened6 will sent a signal to turn off Switch7 so that control signal form Alarm Generator5 can not go through Switch7. Windows are not opened. Lights and horns are not turned on.

1-7. (canceled)

8. A device saving children in hot cars comprising:
a) an occupancy sensor, in the car, comprising at least two kinds of motion sensor,
b) a thermometer in the car,
d) an AND gate has inputs from said motion sensors and an input from said thermometer,
e) an alarm generator,
f) a switch that is connected from said AND gate to said alarm generator.

9. A device saving children in hot cars in claim 8, wherein said motion sensors are infrared motion sensor and ultrasonic motion sensor that send signals to said AND gate when motion is detected in the car.

10. A device saving children in hot cars in claim 8, wherein said thermometer sends signal to said AND gate when the temperature is higher than the predetermined threshold.

11. A device saving children in hot cars in claim 8, wherein said AND gate sends signal to said alarm generator through said switch, if said switch is on, when said AND gate receives signals from both said motion sensors and said thermometer.

12. A device saving children in hot cars in claim 8, wherein said switch is turned on letting signal go from said AND gate to said alarm generator, when and only when all doors of the car are closed.

13. A device saving children in hot cars in claim 8, wherein said alarm generator, connected to control circuits of the car for opening windows and turning on horns and lights, sends signals to open all windows to lower temperature in the car and to turn on all lights and horns of the car to attract attention of people around to help children in danger.

14. A method of saving children in a hot car is opening all windows of the car to lower temperature and turning all horns and light of the car to attract attention people around to help children in danger when the following four conditions are all true
1) an ultrasonic motion sensor detects motion in the car,
2) an infrared motion sensor detects motion in the car,
3) a thermometer detects dangerous high temperature in the car,
4) all the car doors are closed.
